(19) United States
(12) Patent Application Publication
(10) Pub. No.: US 2020/0374410 A1
(43) Pub. Date: Nov. 26, 2020

(54) IMAGE PROCESSING DEVICE AND COMPUTER-READABLE RECORDING MEDIUM STORING PROGRAM THEREON

(71) Applicant: KONICA MINOLTA, INC., Tokyo (JP)

(72) Inventor: Toshihiko OTAKE, Ikeda-shi (JP)

(73) Assignee: KONICA MINOLTA, INC., Tokyo (JP)

(21) Appl. No.: 16/857,235

(22) Filed: Apr. 24, 2020

(30) Foreign Application Priority Data
May 22, 2019 (JP) 2019-096047

(51) Int. Cl. H04N 1/00

(52) U.S. Cl. CPC H04N 1/00482; H04N 2201/0094; H04N 1/00392; H04N 1/00403

(57) ABSTRACT

An image processing device including: a display; a microphone; a hardware processor; and a memory including instructions that when executed by the hardware processor cause the image processing device to: display a default setting screen on the display, the default setting screen being registered in advance; receive a setting via manual operation of the default setting screen; receive a setting via voice input received by the microphone; judge whether or not a setting value according to the voice input is a specific setting value not displayed on the default setting screen; and display a specific screen on the display when judging positively, the specific screen corresponding to the setting value and being different from the default setting screen.

This application claims priority to Japanese patent Application No. 2019-096047, filed on May 22, 2019, the contents of which are hereby incorporated by reference in their entirety.

### BACKGROUND

### (1) Technical Field

The present disclosure relates to an image processing device and a computer-readable recording medium storing a program thereon, and in particular to voice interface technology that flexibly responds to a voice instruction from a user.

### (2) Description of the Related Art

In recent years, as voice recognition accuracy has improved due to advances in voice recognition technology, the demand for voice interfaces for image processing devices has increased, and various voice interfaces have been proposed.

As an example of an operation that can be improved upon by voice operation, when there is a plurality of hierarchically-configured operation screens, when a user wants to set a setting on a lower-layer operation screen while an upper-layer operation screen is displayed, direct manual operation of the setting by pressing a touch panel cannot be performed as long as the upper-layer operation screen does not display the setting. By repeating a touch operation for each operation screen sequentially from the upper-layer operation screen to the lower-layer operation screen, the lower-layer operation screen can be reached, and after the desired setting is displayed, the setting can be set.

On the other hand, when a voice instruction is given, even if the setting is not displayed on the upper-layer operation screen, the setting is directly specified by the voice instruction, causing the lower-layer operation screen to be displayed and the setting to be set. While changing the display from the upper-layer operation screen to the lower-layer due to a voice instruction, there is a disclosed technique of sequentially displaying intermediate operation screens between the upper and lower operation screens (for example, see JP 2007-018090). According to this technique, the labor of switching operation screens can be reduced, and it can be made easy to understand which layer of operation screen has been reached.

Further, there is also a proposed video device that displays on a single operation screen a plurality of settings that are mutually dependent and cannot be set independently of one another (for example, JP 2004-180055). According to this configuration, it is possible to give a voice instruction while visually checking setting options, in order that operability by voice input can be improved.

However, the related art described above only provides alternatives to manual operation in a sense that a previously prepared setting can be set by voice operation on a previously prepared operation screen, and it cannot be said that the possibilities of voice operation have been fully utilized.

For example, while manual operation only allows setting of settings displayed on an operation screen, voice operation allows a user to freely set a setting not displayed on any operation screen.

Such a setting operation cannot be dealt with by the related art described above, and is therefore treated as an erroneous operation or not responded to at all.

Further, sizes of operation screens of an image processing device are limited, and therefore it is not possible to display in advance on an operation screen all settings that may be set by voice instruction.

### SUMMARY

The present disclosure is made in view of the problems described above, and has an object of providing an image processing device and a computer-readable recording medium storing a program that can respond to a voice instruction for a setting for which an operation screen is not prepared in advance.

To achieve at least one of the abovementioned objects, an image processing device according to an aspect of the present disclosure is an image processing device including: a display; a microphone; a hardware processor; and a non-transitory computer-readable memory comprising computer-executable instructions that when executed by the hardware processor are configured to cause the image processing device to: display a default setting screen on the display, the default setting screen being registered in advance; receive a setting via manual operation of the default setting screen; receive a setting via voice input received by the microphone; judge whether or not a setting value according to the voice input is a specific setting value not displayed on the default setting screen; and display a specific screen on the display when judging positively, the specific screen corresponding to the setting value and being different from the default setting screen.

### BRIEF DESCRIPTION OF THE DRAWINGS

The advantages and features provided by one or more embodiments of the invention will become more fully understood from the detailed description given below and the appended drawings which are given by way of illustration only, and thus are not intended as a definition of the limits of the invention. In the drawings:

FIG. 1 is a perspective diagram illustrating structure of a multi-function peripheral (MFP) 1 pertaining to an embodiment;

FIG. 2 is a frontal view diagram illustrating structure of an operation panel 100 of the MFP 1;

FIG. 3 is a block diagram illustrating structure of a controller 122;

FIG. 4 illustrates a color setting screen 4 displayed on a liquid crystal display (LCD) 311 of the operation panel 100;

FIG. 5A illustrates a brown color screen 5 displayed on the LCD 311 of the operation panel 100 prior to changing an intensity value of brown;

FIG. 5B illustrates the brown color screen 5 displayed on the LCD 311 of the operation panel 100 after changing the intensity value of brown;

FIG. 6 illustrates a color adjustment screen 6 displayed on the LCD 311 of the operation panel 100;

FIG. 7 illustrates structure of an instruction registration table;

FIG. 8 illustrates a flowchart of a process for receiving an operation with respect to a default setting screen (color setting screen 4);

FIG. 9 illustrates a template for generating a specific screen for voice-instructed color setting;

FIG. 10 illustrates a flowchart of a process for receiving an operation with respect to a specific screen (color setting screen 5);

FIG. 11A illustrates a color balance (detailed setting) screen, which is a default setting screen prior to receiving a voice instruction from a user; and

FIG. 11B illustrates a color balance (detailed setting) screen, which is a specific screen after receiving a voice instruction from a user.

### DETAILED DESCRIPTION

Hereinafter, one or more embodiments of the present invention will be described with reference to the drawings. However, the scope of the invention is not limited to the disclosed embodiments.

### (1) Structure of Image Processing Device

First, structure of an image processing device pertaining to an embodiment is described below.

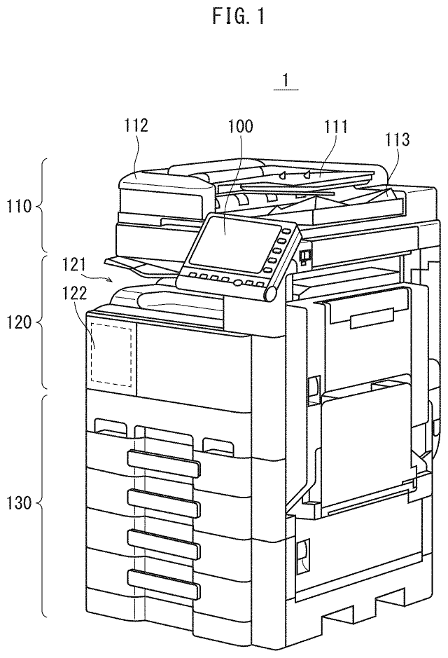

The image processing device pertaining to an embodiment is a multi-function peripheral (MFP), and as illustrated in FIG. 1 includes an image reader 110, an image former 120, and a sheet feeder 130. The image reader 110 feeds out documents one by one from stack of documents set on a document tray 111 by using an automatic document feeder (ADF) 112, and reads the documents by using a “sheet-through method” before discharging the documents to a discharge tray 113. In this way, image data is generated.

The image former 120 includes an imaging unit that forms a toner image and transfers it to a sheet and a fixing unit that heat-fixes the toner image to the sheet. Image forming processing is executed using image data generated by the image reader 110 or received via a communication network such as a local area network (LAN) or the Internet. The sheet feeder 130 stores sheets and supplies sheets in parallel with toner image formation by the image former 120. A sheet onto which a toner image has been transferred and heat-fixed is discharged onto the discharge tray 121 provided in an internal space of the MFP 1.

The MFP 1 includes an operation panel 100. The operation panel 100 presents information to a user of the MFP 1 and receives instruction input from a user via manual operation and voice operation. Further, the MFP 1 includes a controller 122. The controller 122 controls operations of the MFP 1.

### (2) Operation Panel 100

The following describes structure of the operation panel 100.

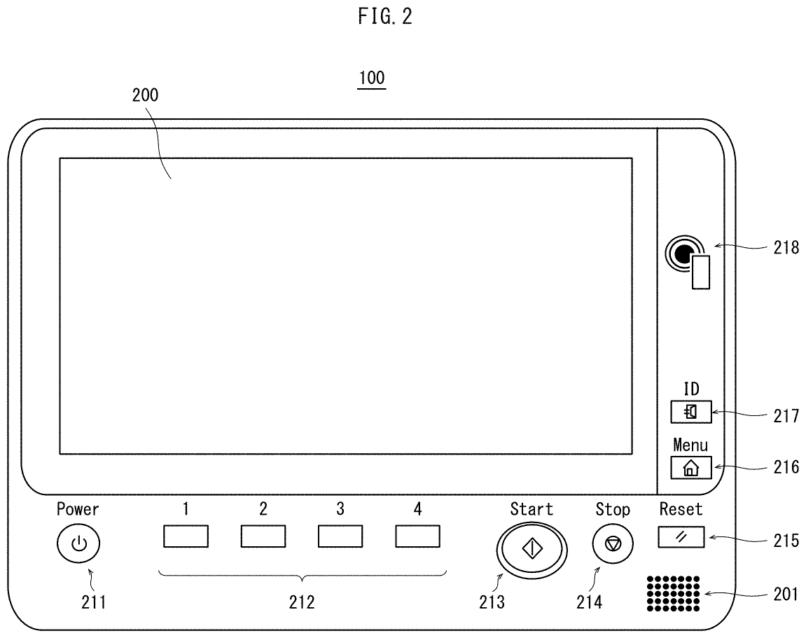

As illustrated in FIG. 2, the operation panel 100 includes a touch panel 200, a microphone 201, a power key 211, hard keys 212, a start key 213, a stop key 214, a reset key 215, a menu key 216, and an identification (ID) key 217. The touch panel 200 includes a liquid crystal display (LCD) and a touch pad, displays screens for a user, and receives touch input from a user. The microphone 201 is for receiving voice input from a user.

The power button 211 is a key for switching on power of the MFP 1, and the hard keys 212 can be customized by a user to execute functions when pressed. The start key 213 is a key for starting execution of a job after setting of execution conditions for the job is complete. The stop key 214 is a key for stopping a job during execution. The reset key 215 is a key for resetting settings in a displayed screen.

The menu key 216 is a key for causing display of a top menu. The ID key 217 is a key for starting an authentication process when the operation panel 100 is in a logged out state, and for logging out when the operation panel 100 is in a logged in state. Further, the operation panel 100 includes a short-range wireless communication interface 218 for communicating with a mobile terminal or the like.

Further, the operation panel 100 includes a speaker (not illustrated), and can output sound using the speaker.

### (3) Controller 122

The following describes structure of the controller 122.

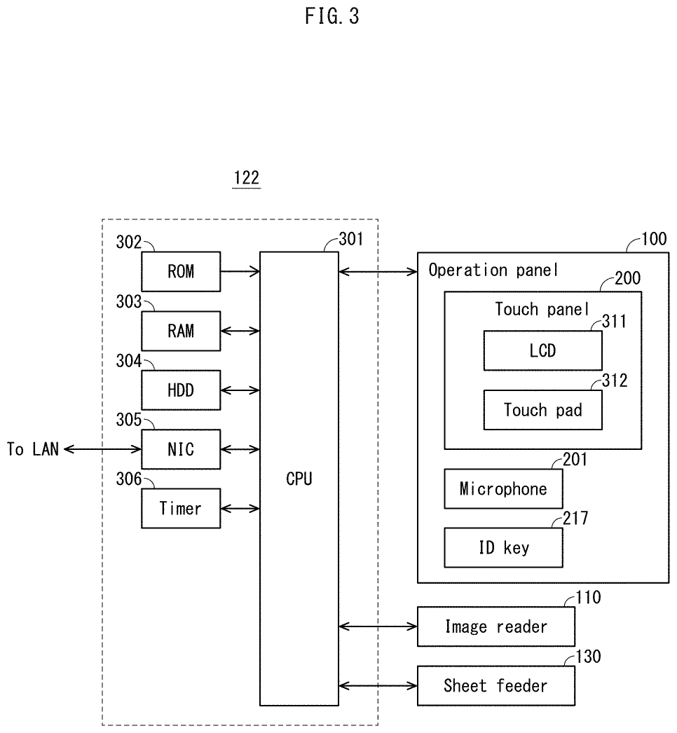

As illustrated in FIG. 3, the controller 122 includes a central processing unit (CPU) 301, read-only memory (ROM) 302, random access memory (RAM) 303, and the like. The CPU 301 reads out a boot program from the ROM 302 and boots up after a reset, then uses the RAM 303 as a work memory area and reads out and executes an operating system (OS), control program, and the like from a hard disk drive (HDD). A network interface card (MC) 305 executes communication processing for connecting with another device via a LAN, the Internet, or the like. A timer 306 is started after setting a time, starts counting down, and upon timing out notifies the CPU 301 via a timer interrupt that the set time has elapsed.

With such a structure, the controller 122 controls operations of the image reader 110, the image former 120, and the sheet feeder 130. In particular, a screen is displayed and touch input is received by using the LCD 311 and the touch pad 312 that constitute the touch panel 200 of the operation panel 100. Further, when the microphone 201 converts a user voice operation into a voice signal, the controller 122 executes voice recognition processing or the like using the voice signal. Further, upon detecting that the ID key is pressed, the controller 122 executes display of an authentication processing screen on the LCD 311 for authentication processing or executes logout processing.

### (4) Color Setting Processing for Copying

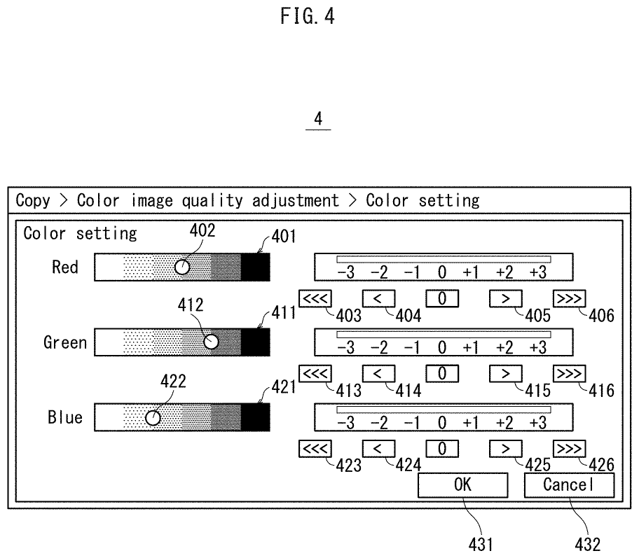

The following describes color setting processing for copying as an example of processing executed by the controller 122. Here, color setting processing for copying is processing for receiving a color setting for executing monochrome copying. For example, as illustrated in FIG. 4, a color setting screen 4 is displayed on the LCD 311 of the operation panel 100 and a color setting is received.

In the color setting screen 4, color settings are accepted by designating intensities of three primary colors of red, blue, and green within ranges of 0 to 255. For example, a red intensity can be set by an intuitive operation of sliding a handle 402 of a slider bar 401 left and right. In this way, a state of red intensity can be visually displayed by the handle 402. The following description also applies to other colors (green, blue, brown).

Further, since it is not always easy to make fine adjustments to the handle 402 by a touch operation, touch keys 403, 404, 405, and 406 may be used to make fine adjustments to the red intensity value. For example, the touch key 403 is a key for decreasing the red intensity value by three, and the touch key 404 is a key for decreasing the red intensity value by one. Similarly, the touch key 405 is a key for increasing the red intensity value by one, and the touch key 406 is a key for increasing the red intensity value by three.

Further, intensity values may be adjusted by voice instruction. When the touch keys 403, 404, 405, 406 are operated, or when an intensity is adjusted by a voice instruction, a display position of the handle 402 of the slider bar 401 is changed according to the intensity value after adjustment, as when the handle 402 is moved by a touch operation.

When an intensity value is changed by using the handle 402 or the touch keys 403, 404, 405, 406, text such as “very light”, “light”, “slightly light”, “medium”, “slightly dark”, “dark”, “very dark” may be output as audio to indicate an intensity value after the change, or text such as “the intensity value is 198” may be output as audio to indicate the intensity value.

A user that hears such output from a speaker may subsequently when setting the intensity for any color input the same audio into a microphone, thereby setting the intensity for that color to the corresponding intensity value. Similar audio output may be performed when an intensity value is changed for a color other than red, such as green, blue, or brown. Further, the text may be displayed on the operation panel 100 instead of or in addition to the audio output.

Similarly, green and blue intensity values can be intuitively set using slider bars 411, 421, or can be finely adjusted using touch keys 413 to 416 and 423 to 426. When a user who has finished color setting touches an OK key 431, the controller 122 stores the color setting and returns to an upper level screen. Or, if a user touches a cancel key 432, the color setting is discarded without being stored and the screen returns to the upper level screen.

By performing a manual operation on a such a color setting screen, it is difficult to set, for example, a brown color, unless intensity values of each color component are known in advance. Brown intensity in particular is difficult to set. However, according to the present embodiment, when it is determined by a voice operation that a user desires to set a brown color, a brown color setting screen is displayed.

In this case, the controller 122 may prepare a brown color setting screen in advance, or may generate a brown color setting screen in response to a voice instruction from a user. According to the present embodiment, a template for generating a setting screen for a specific color is stored in advance, to display a color designated by voice by a user and a gradation image showing a gradation of intensity values of the color from 0 to 255.

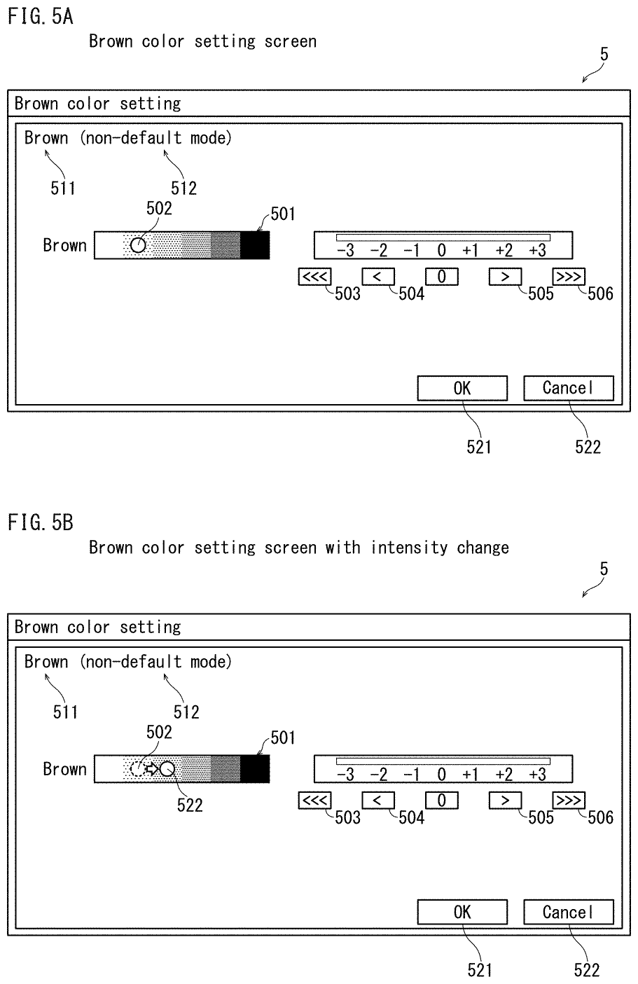

A brown color setting screen 5 illustrated in FIG. 5A is a brown color setting screen displayed on the LCD 311 when a user makes a color setting such as “light brown” in the color setting screen 4. On the brown color setting screen 5, a character string 511 “brown” is displayed indicating the color for the color setting screen and a character string 512 “Non-default mode” is displayed indicating that the screen is displayed only by a voice instruction and not by a manual operation on another screen.

Further, on the brown color setting screen 5, a slider bar 501 for setting a brown color intensity value is displayed, which is a brown gradation image. By moving a handle 502 of the slider bar 501 by a touch operation, the brown color intensity value can be changed. When a user wishes to finely adjust the intensity value, touch keys 503, 504, 505, 506 may be used to perform the same operation described with reference to the color setting screen 4.

Further, the intensity value can be changed by voice instruction. For example, when a user gives a voice instruction “darker”, the handle of the slider bar 501 moves by an intensity value associated in advance with the word “darker”, from a position 502 to a position 521 as illustrated in FIG. 5B. A user may specify an intensity value by a voice instruction such as “20 steps lighter”, and in such a case the handle of the slider bar 501 moves by the intensity value specified.

An OK key 52 land a cancel key 522 function similarly to those of the color setting screen 4.

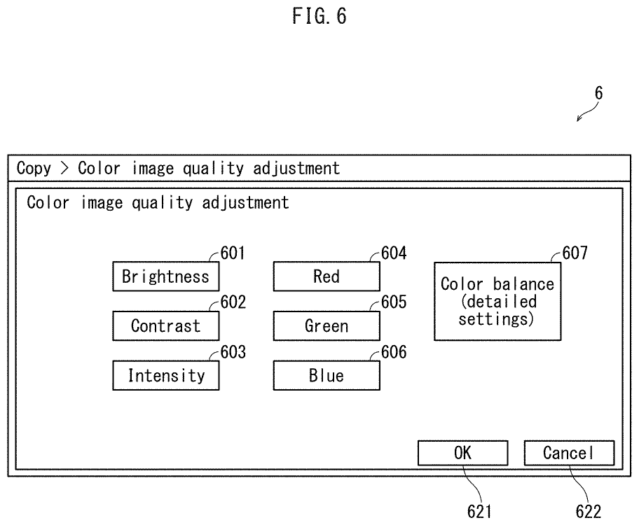

FIG. 6 is a diagram illustrating a color image quality adjustment screen 6 displaying keys for causing display of the color setting screen 4. The color image quality adjustment screen 6 display a brightness key 601, a contrast key 602, an intensity key 603, a red color key 604, a green color key 605, a blue color key 606, and a color balance key 607, as well as an OK key 621 and a cancel key 622 as in the color setting screen 4.

Touching the brightness key 601, the contrast key 602, or the intensity key 603 causes display of a brightness setting screen, contrast setting screen, or intensity setting screen, respectively, and touching the red color key 604, the green color key 605, or the blue color key 606 causes display of the color setting screen 4. Further, touching the color balance key 607 may cause display of a color balance setting screen, described later.

Adjusting the brown intensity value by individual adjustment of intensity values for red, green, and blue means that a combined color of red, green, and blue intensity values is not displayed, and it is very difficult for a user to search for a target color by specifying each coordinate value in a three-dimensional space composed of red, green, and blue intensity values.

On the other hand, if the handle 502 is operated, by touch or otherwise, while the brown gradation image is displayed, a user only needs to search for a target value in a one-dimensional space composed of only brown intensity values, making it easy to specify brown intensity. In this way, when the brown color setting screen 5 is displayed due to a user voice instruction, it is possible to perform a one-dimensional level setting without the need for a multi-dimensional level setting, and therefore specifying brown color intensity is made easier.

When the brown color intensity is specified, it is easy for the controller 122 to calculate the intensities for red, blue, and green from the specified brown color intensity.

### (5) Controller 122 Operations

The following describes operations of the controller 122.

When a user gives a voice instruction while the color setting screen 4 is displayed, the controller 122 converts the user's voice instruction into a voice signal by using the microphone 201, and further generates a digital voice signal, or voice data, by analog to digital (A/D) conversion, and executes voice recognition processing using the voice data. In the voice recognition processing, first, a noise reduction algorithm is used to reduce a noise level of the voice data, then text data is generated from the voice data after noise reduction. When generating text data from voice data, a known voice recognition algorithm can be used.

Subsequently, the user's instruction is extracted from the text data by natural language processing. In the controller 122, for each screen, an instruction that can be accepted is registered, and for each instruction, information indicating whether or not manual instruction by a touch operation can be performed is stored. For example, an instruction requesting a brown color setting is registered in advance, such as a voice instruction “light brown”, and information is stored indicating that this instruction cannot be manually input by a touch operation on the color setting screen 4, which is a default setting screen.

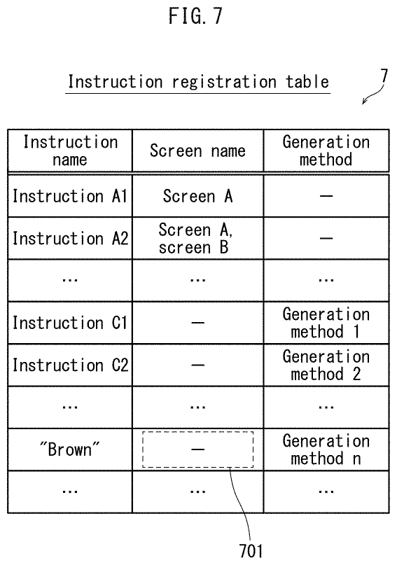

The controller 122 registers in advance instructions that can be received from a user in a list table (also referred to as an “instruction registration table”). An “instruction name”, a “screen name” of a screen that can receive a corresponding instruction by a touch operation, a “generation method” of a specific screen, and a “default registration method” of a corresponding specific screen are registered in the instruction registration table. According to the instruction registration table 7 illustrated in FIG. 7, instructions A1, A2 can be given by a touch operation on screen A, and the instruction A2 can be given by a touch operation on screen B. The instruction A2 is an instruction corresponding to a key that can be displayed on a plurality of screens, such as an OK key for example.

On the other hand, instructions C1, C2 cannot be given by a touch operation. When an instruction C1 or C2 is given by a voice operation, the controller 122 refers to the generation method corresponding to the instruction to cause display of a specific screen corresponding to the instruction on the operation panel 100. For example, when a voice instruction “brown” is given, the instruction is registered in the instruction registration table but a corresponding “screen name” is not, and therefore the controller 122 refers to the “generation method” column to generate the brown color setting screen 5, and causes display on the operation panel 100.

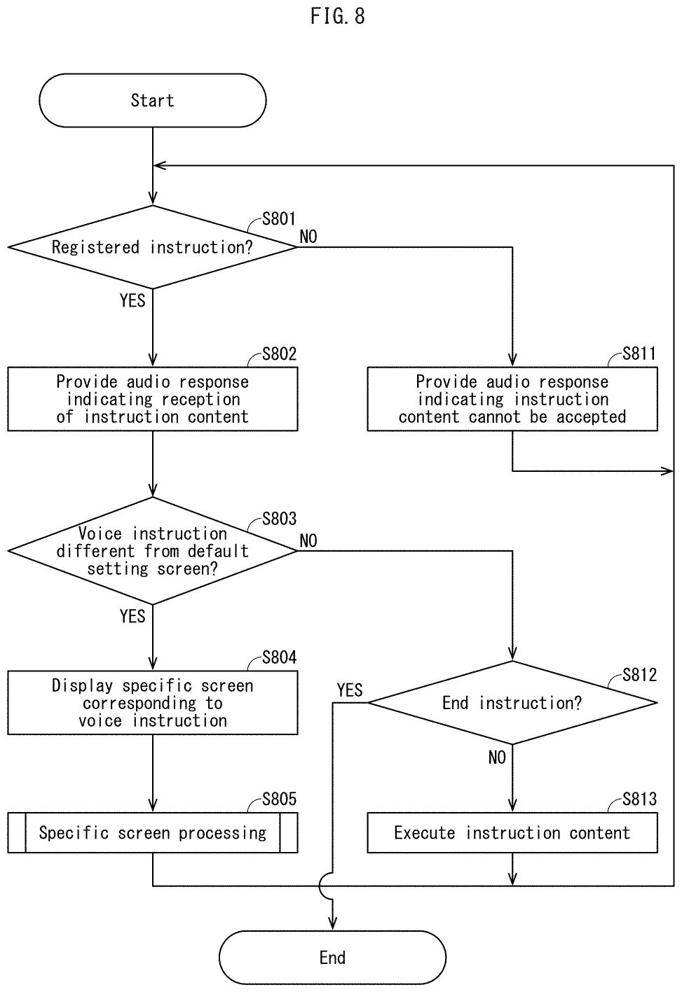

As illustrated in FIG. 8, when content of a user's voice instruction does not correspond to an instruction pre-registered in the instruction registration table (S801: NO), an audio output is executed indicating that the instruction content cannot be accepted (S811), and processing proceeds to step S801. In this case, the audio output may be a simple beep or may be a synthesized voice with corresponding content. Further, instead of audio output or in addition to audio output, a screen indicating that the instruction content cannot be accepted may be displayed on the operation panel 100.

In the case of an instruction by touch operation, the instruction must be an instruction displayed on a default setting screen and given by a touch operation or an instruction given by pressing a key provided on the operation panel 100, and therefore must be an instruction registered in advance. When instruction content from a user corresponds to an instruction registered in advance (S801: YES), an audio response is given indicating that the instruction content has been accepted (S802).

Next, if the voice instruction is not different from instructions corresponding to a default setting screen, or in other words if the instruction is displayed on a default setting screen and corresponds to an instruction that can be given by a touch operation (S803: NO), the content of the instruction is referred to. If the instruction is an end instruction (S812: YES), processing ends. According to the present embodiment, this means returning from the color setting screen 4, which is a default setting screen, to the color image quality adjustment screen 6, which is a higher level screen. If the instruction is not an end instruction (S812: NO), the instruction is executed (S813) and processing proceeds to step S801.

If an instruction from a user is a voice instruction different from instructions corresponding to a default setting screen, or in other words if the instruction is not displayed on a default setting screen and cannot be given by a touch operation (S803: YES), the instruction registration table 7 is referred to and a specific screen corresponding to content of the voice instruction is displayed (S804). For example, if a voice instruction is “light brown”, a column is referred to where “instruction name” is “brown” in the instruction registration table 7, and a specific screen is generated according to a generation method n that corresponds to “brown”.

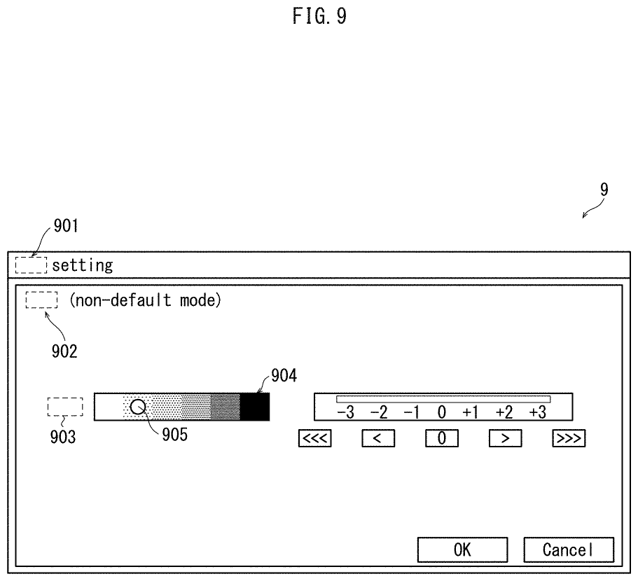

As an example of the generation method n, as illustrated in FIG. 9, a setting screen template 9 for a user-specified color and color balance for the colors RGB corresponding to “brown” are pre-registered, and the controller 122 substitutes the character string “brown” for blank fields 901, 902, 903 in the template 9, and causes display of a “brown” gradation image on a slider bar 904 using an RGB color balance. Basic colors other than red, green, blue (RGB) may be used, such as yellow, magenta, cyan (YMC).

Further, the controller 122 includes a dictionary for associating words expressing color lightness with corresponding intensity values, refers to the dictionary to specify an intensity value corresponding to an instruction such as “light”, then causes display of a handle 905 at a position corresponding to the intensity value specified.

After displaying on the operation panel 100 a specific screen generated in this way, the controller 122 executes the following specific screen processing (S805). When the specific screen processing is completed, processing proceeds to step S801 and processing is repeated.

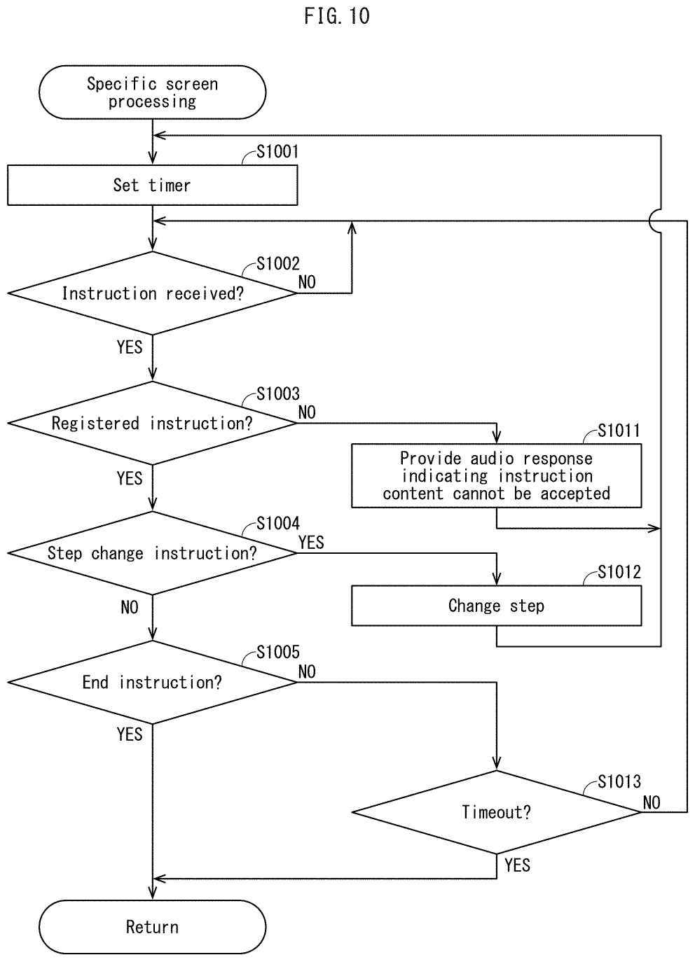

According to the specific screen processing, as illustrated in FIG. 10, the controller 122 first sets a timer 306 to a defined time (S1001). The defined time is for protecting security and enabling other users to use the MFP 1 if no operation is performed with respect to the specific screen for at least the defined time.

While the specific screen is displayed on the operation panel 100, if an instruction is received from a user (S1002: YES), whether or not the instruction is registered in the instruction registration table is checked. If the instruction is not registered in the instruction registration table (S1003: NO), an audio response is made indicating that the instruction cannot be accepted (S1011), and processing proceeds to step S1001. This causes a timer value to reset, restarting timing of the period during which no user has performed an operation.

On the other hand, if the instruction is registered in the instruction registration table (S1003: YES), then, for example if a step change instruction including an instruction to change a brown intensity is received (S1004: YES), the step value is changed in the RAM 303 (S1012), and processing proceeds to step S1001. A step change instruction is not limited to a voice instruction, and may be received by a touch operation. Further, a display state of the specific screen may be updated in accordance with a change in step value, as in the movement of the position of the handle 502 of the brown color setting screen 5 in accordance with an intensity change.

Further, if an end instruction is received (S1005: YES), the screen returns to a default setting screen. For example, if an end instruction is received in a state in which the brown color setting screen is displayed on the operation panel 100, the screen returns to the color setting screen 4 displayed previously. Further, if the color image quality adjustment screen 6 is registered as a default for the brown color setting screen 5 while the brown color setting screen 5 is displayed on the operation panel 100, the screen may return to the color image quality adjustment screen 6.

If an end instruction is not received (S1005: NO), whether or not a timeout has occurred is checked, and if a timeout has occurred (S1013: YES), the screen returns to a default setting screen. If a timeout has not occurred (S1013: NO), processing proceeds to S1002 to continue time measurement of a period in which no user operation is performed.

### (6) Modifications

The present disclosure describes at least one embodiment, but is of course not limited to any embodiment described, and the following modifications can be implemented.

(6-1) According to an embodiment described above, an example is described of a voice instruction “light brown” being received while the color setting screen 4 is displayed, but the present disclosure is of course not limited to this example, and the following examples may be used instead of the color setting screen 4.

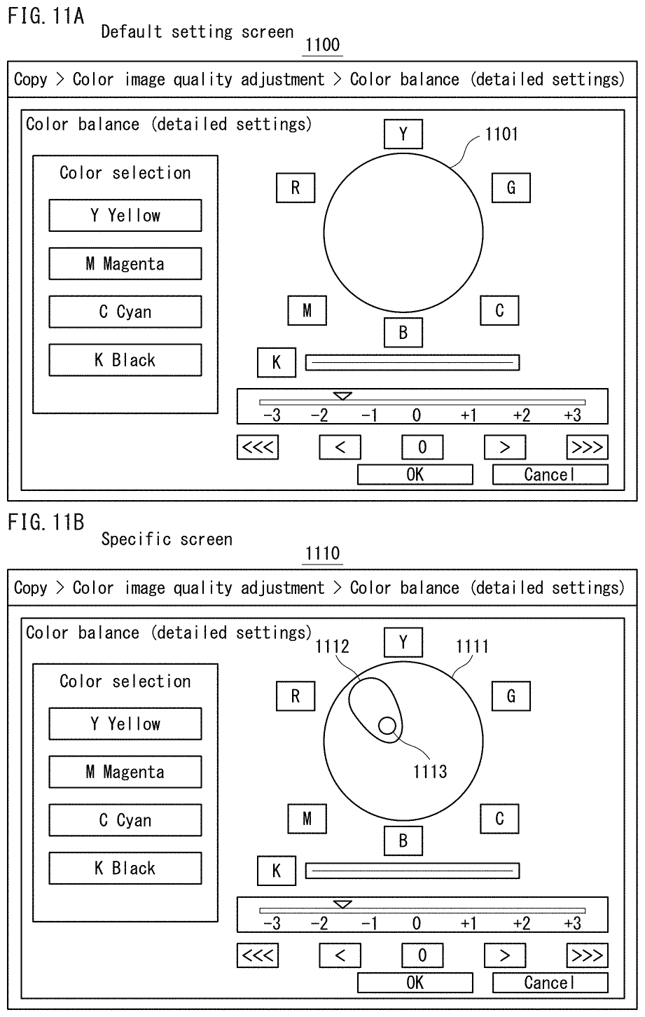

The following describes a case in which a touch operation applied to a color balance (detailed setting) key 607 in the color image quality adjustment screen 6 causes a color balance (detailed setting) screen 1100 as illustrated in FIG. 11A to be displayed as a default setting screen. In the color balance screen 1100, a hue diagram is displayed in color inside a circle 1101, and by touching a point inside the circle 1101, a color at the touched position is set as a copy color.

However, on such a color balance screen 1100, it is not always easy to specify a copy color by a voice instruction. Thus, for example, when a user gives a voice instruction “light brown”, then, as illustrated in FIG. 11B, an area corresponding to brown of various intensities (also referred to as an “adjustment area”) in a circle 1111 is indicated by display of an encircling line 1112, and a handle 1113 is displayed at a position corresponding to light brown (for example, a position reached by adding a defined value for lightness to coordinates for a basic color of RGB value preset to be brown). This is also referred to as a “specific display”.

In this way, when the specific screen 1110 on which the specific display is superimposed on the adjustment area 1111 of the default setting screen 1100 in response to a user's voice instruction, a desired copy color can be easily specified even by voice instruction.

(6-2) According to an embodiment described above, an example is described in which brown color setting by voice instruction is facilitated by a voice instruction different from any instructions on a default setting screen, but of course the present disclosure is not limited to this example, and the following examples may be implemented instead of or in addition to this.

If operation target colors displayed on a default setting screen are red, green, and blue, then colors other than brown, such as purple and orange may be registered in advance to enable display of a purple color setting screen and an orange color setting screen, in order to specify a corresponding color intensity.

Further, if options presented on the operation panel 100 for layout adjustment are only 1 in 1, 2 in 1, 4 in 1, and 8 in 1, a voice instruction such as 3 in 1 or 5 in 1 may be accepted. Further, if options presented on the operation panel 100 for paper selection are only A3, A4, B4, B5, postcard, and L size, then options other than these, such as a square sheet or the like may be accepted as a selection for a voice instruction.

As described above, if options other than options displayed on-screen are accepted by voice instruction, there is no need to have an unnecessarily large number of options displayed, which would make viewing and operation difficult, and a user can selected a desired option directly by reception of a voice instruction, and therefore convenience for a user can be improved.

(6-3) According to an embodiment described above, the brown color setting screen is one aspect of image quality adjustment, and image quality adjustment includes color tone adjustment. Color tone adjustment includes a level adjustment corresponding to a specific color tone (for example, “brown”) for which a user of the MFP 1 has given a voice instruction, and this level adjustment may be an adjustment of intensity, for example.

Further, the level adjustment may be an adjustment changing tone to a different color tone, centered on a color tone for which a user gave a voice instruction. In this case, a screen is displayed in which a representative color (for example, “brown”) corresponding to the tone for which a user gave a voice instruction (for example, “light brown”) is displayed centrally, such that a level adjustment may be performed with respect to the screen.

Further, as illustrated in FIG. 11B, while displaying the encircling line 1112 corresponding to a color tone for which a user gave a voice instruction, the handle 1113 of the color tone within the encircling line 1112 (for example, “light brown”) may be indicated, and may be changed to a different color tone from the color tone pertaining to the handle 1113. In this way, it is possible for a user to change a color tone for which the user gave a voice instruction (handle 1113) to a color tone within a specific range (area 1112).

(6-4) Although not described in detail with respect to an embodiment described above, specific screens such as the brown color setting screen 5 are registered in advance in the MFP 1 (for example, in the HDD 304), and access aside from voice input may be restricted so that only an administrator of the MFP 1 has access.

(6-5) According to an embodiment described above, the image processing device is the MFP 1, but the present disclosure is of course not limited to this example, and similar effects can be obtained by applying the present disclosure to a single-function device such as a printer, a scanner, a copier, a facsimile device, or the like.

(6-6) As described above, the image forming system 1 and the MFP control server 101 are computer systems each including a microprocessor and a memory. The memory may store a computer program and the microprocessor may operate according to the computer program.

Here, the computer program is configured by combining a plurality of instruction codes indicating instructions to a computer in order to achieve defined functions.

Further, the computer program may be recorded on a computer-readable recording medium, such as a flexible disk, a hard disk, an optical disk, a semiconductor memory, or the like.

Further, the computer program may be transmitted by a wired or wireless telecommunication line, a network such as the Internet, data broadcasting, or the like.

(6-7) Embodiments and modifications described above may be combined with each other.

### (7) Review

An image processing device according to an aspect of the present disclosure is an image processing device including: a display; a microphone; a hardware processor; and a non-transitory computer-readable memory comprising computer-executable instructions that when executed by the hardware processor are configured to cause the image processing device to: display a default setting screen on the display, the default setting screen being registered in advance; receive a setting via manual operation of the default setting screen; receive a setting via voice input received by the microphone; judge whether or not a setting value according to the voice input is a specific setting value not displayed on the default setting screen; and display a specific screen on the display when judging positively, the specific screen corresponding to the setting value and being different from the default setting screen.

According to an embodiment, the specific screen is generated in response to the setting value.

According to an embodiment, a keyword and a generation method of generating the specific screen according to the keyword are registered in advance, and the specific screen is generated according to the generation method corresponding to the keyword in the voice input.

According to an embodiment, the setting value is displayed on the specific screen such that the setting value can be viewed.

According to an embodiment, when the setting value is changed, text corresponding to the setting value is output as audio via a speaker or as text on the display.

According to an embodiment, the specific screen is a screen related to image quality adjustment.

According to an embodiment, the image quality adjustment is a color adjustment.

According to an embodiment, the color adjustment is an adjustment related to a color specified by the voice input.

According to an embodiment, the color adjustment is a change from a color specified by the voice input to a color within a specific range from the color specified.

According to an embodiment, the change is received by setting of a value for an item displayed on the specific screen such that the value can be viewed.

According to an embodiment, the specific screen displays a range on a hue diagram to receive the color adjustment.

According to an embodiment, the default setting screen is a setting screen from which it is possible to adjust color according to defined basic colors, and the specific screen is a setting screen for color adjustment in a color range corresponding to the specific setting value.

According to an embodiment, the specific screen is a setting screen for intensity adjustment in the color range corresponding to the specific setting value.

A recording medium according to an aspect of the present disclosure is a non-transitory computer-readable recording medium including computer-executable instructions that when executed by a hardware processor are configured to cause the hardware processor to: receive a setting via manual operation of a default setting screen registered in advance; receive a setting via voice input; judge whether or not a setting value according to the voice input is a specific setting value not displayed on the default setting screen; and cause display of a specific screen corresponding to the setting value when judging positively, the specific screen being different from the default setting screen.

According to these embodiments, a specific screen corresponding to a setting value set according voice input is displayed in response to the voice input, and therefore it is possible to respond to voice input of a setting value for which a default setting screen is not prepared in advance.

Although embodiments of the present invention have been described and illustrated in detail, the disclosed embodiments are made for purposes of illustration and example only and not limitation The scope of the present invention should be interpreted by terms of the appended claims.

What is claimed is:

1. An image processing device comprising:
a display; a microphone; a hardware processor; and a non-transitory computer-readable memory comprising computer-executable instructions that when executed by the hardware processor are configured to cause the image processing device to:
display a default setting screen on the display, the default setting screen being registered in advance;
receive a setting via manual operation of the default setting screen;
receive a setting via voice input received by the microphone;
judge whether or not a setting value according to the voice input is a specific setting value not displayed on the default setting screen; and
display a specific screen on the display when judging positively, the specific screen corresponding to the setting value and being different from the default setting screen.

2. The image processing device of claim 1, wherein
the specific screen is generated in response to the setting value.

3. The image processing device of claim 2, wherein
a keyword and a generation method of generating the specific screen according to the keyword are registered in advance, and
the specific screen is generated according to the generation method corresponding to the keyword in the voice input.

4. The image processing device of claim 1, wherein
the setting value is displayed on the specific screen such that the setting value can be viewed.

5. The image processing device of claim 4, wherein
when the setting value is changed, text corresponding to the setting value is output as audio via a speaker or as text on the display.

6. The image processing device of claim 1, wherein
the specific screen is a screen related to image quality adjustment.

7. The image processing device of claim 6, wherein
the image quality adjustment is a color adjustment.

8. The image processing device of claim 7, wherein
the color adjustment is an adjustment related to a color specified by the voice input.

9. The image processing device of claim 7, wherein
the color adjustment is a change from a color specified by the voice input to a color within a specific range from the color specified.

10. The image processing device of claim 9, wherein
the change is received by setting of a value for an item displayed on the specific screen such that the value can be viewed.

11. The image processing device of claim 8, wherein
the specific screen displays a range on a hue diagram to receive the color adjustment.

12. The image processing device of claim 1, wherein
the default setting screen is a setting screen from which it is possible to adjust color according to defined basic colors, and
the specific screen is a setting screen for color adjustment in a color range corresponding to the specific setting value.

13. The image processing device of claim 12, wherein
the specific screen is a setting screen for intensity adjustment in the color range corresponding to the specific setting value.

14. A non-transitory computer-readable recording medium comprising computer-executable instructions that when executed by a hardware processor are configured to cause the hardware processor to:
receive a setting via manual operation of a default setting screen registered in advance;
receive a setting via voice input;
judge whether or not a setting value according to the voice input is a specific setting value not displayed on the default setting screen; and
cause display of a specific screen corresponding to the setting value when judging positively, the specific screen being different from the default setting screen.
